(19) United States
(12) Patent Application Publication
(10) Pub. No.: US 2007/0222207 A1
(43) Pub. Date: Sep. 27, 2007

(54) Produce label having two different images viewable from front and back of label and method of making same

(76) Inventors: Andrew G. Hendry, Norwich (GB); M. Scott Howarth, Clovis, CA (US); Colin P. Ladell, Norwich (GB); Philip J. Starks, Norwich (GB)

Correspondence Address: Bruce H. Johnsonbaugh;Eckhoff & Hoppe, Suite 2800, 101 Montgomery Street, San Francisco, CA, 94104, US

(21) Appl. No.: 11/725,854

(22) Filed: Mar. 20, 2007

Related U.S. Application Data
(60) Provisional application No. 60/784,860, filed on Mar. 22, 2006.

(51) Int. Cl. B42D 15/00

(52) U.S. Cl. 283/101

(57) ABSTRACT

A dual image label web carrying a plurality of labels to be applied to single items of produce is provided and a method of making the same. A transparent label film strip made of either polyester or low density polyethylene has a transparent pressure sensitive adhesive applied to its lower surface. A release liner is carried by the pressure sensitive adhesive. The film strip is heated to between 110° F. and 135° F. and then three ink layers are applied to the upper surface of the plastic film strip. The first ink layer is a water based ink and includes a plurality of reverse printed images. The reverse images may be authentication images or promotional images. A second, opaque layer is applied over the layer of reverse images. The opaque covering is formed with a solvent based ink having a coat weight sufficiently large to prevent images on either side of the opaque coating from being visible through the coating. A third layer of water based ink is then applied over the opaque coating having front printed images. All three ink layers are applied from the same side of the plastic film strip. An optional top coating of varnish may be applied.

### CROSS-REFERENCE TO RELATED APPLICATION

This application claims the benefit of and priority from U.S. provisional application Ser. No. 60/784,860 filed Mar. 22, 2006.

### BACKGROUND AND BRIEF SUMMARY OF INVENTION

The present invention pertains generally to labels applied either automatically or manually to individual, fresh produce items. More particularly, the present invention provides a novel method of making produce labels utilizing a thin plastic polymer film and having “dual images” applied to one surface of the thin plastic polymer film. The invention also pertains to the novel label, itself.

Produce labels for fruit and vegetables have become commonplace. Hundreds of millions of such labels are applied daily around the world and the demand continues to increase. These removable labels are often read carefully by customers and are therefore highly desirable for advertising and other promotional communications. Unfortunately, the labels are typically small and capable of carrying only limited information on their front surfaces. A significant demand exists for a system of utilizing removable produce labels as a medium for carrying advertising and promotional messages.

A related problem is that counterfeit produce items are appearing in increasing numbers in various areas around the world. Unscrupulous competitors are applying branded labels, without permission from the brand owner, to unbranded produce items, such as fresh citrus fruits. The brand owners are seeking some method of applying an authenticating legend to produce labels to thwart the counterfeiters.

One approach is to simply increase the size of the label to add more area for promotional and/or anti-counterfeiting legends. This approach is undesirable in many respects. Customers would almost certainly dislike removing larger labels from apples, pears and other produce items. Retailers would dislike the higher cost of larger labels in the highly cost sensitive fresh food business. Label suppliers would resist the large costs required in possible retooling.

Finally, and perhaps most importantly, significantly larger labels would present technical challenges which are not easily overcome. As noted below in detail, an inherent problem with produce labels is known as “curling.” Curling refers to the tendency of a printed label to bend or curl at its edges in a direction toward the applied ink. Curling is caused in part by the applied ink shrinking as it dries. Labels that are twice the size of existing labels would have a greater tendency to curl. The problem of curling is aggravated in produce labeling, as shown and described below, because the surface of the produce item is always curved in a direction opposite to the direction that the label inherently tends to curl.

A second approach to adding information to produce labels is to use “dual images,” i.e., one image viewable from the front of the label and a second image viewable from the rear of the label. The use of “dual images” generally is known in the prior art. For example, the prior art includes use of dual images by printing a first image onto a label (typically a heavy paper material) from a first side of the label, and printing a second image onto the label from the second, opposite side of the label. Printing both sides of a label inherently increases costs caused by the delaminating and relaminating of the label stock [see FIG. 1 of published UK patent application GB 2,341,138A and see U.S. Pat. No. 5,452,959 and EP 0700788 A2].

The prior art also includes the printing of dual images from a single side of the label web, wherein a “reverse” image is applied to the web, then an opaque or blocking layer is applied, and then the “front” image is finally applied [see FIGS. 2-5 of GB 2,341,138A, noted above]. That technique has not, to the knowledge of applicants, ever been used in produce labeling. Furthermore, by way of example, the technique of GB 2,341,138A is applicable to labels permanently applied to bottles, but not to removable labels applied to produce items. The technique taught by GB 2,341,138A uses a “dual image” label, but the problem of “curling” is simply overcome by use of an aggressive adhesive, since the label is not removable from the bottle. However, when the label must be easily removable, as in the case of the present invention, the problem of curling is a paramount problem. Aggressive adhesives used on labels permanently attached to bottles are not usable on produce; those adhesives would tend to require removal of flesh of the produce item with the label. That consequence is simply unacceptable to consumers.

The present invention provides a method of making novel labels for use on produce items wherein dual images are applied to a transparent, thin polymer film from a single side of the film. An opaque layer is applied between the reverse image and a front or forward image. The present invention has overcome the problem of “curling” by using a novel combination of a solvent based ink for the opaque layer and water based ink for the two image layers, together with the application of heat as the three ink layers are applied to the film.

A primary object of the invention is to provide a novel dual image label web, and method of making same, having a plurality of labels for application to individual produce items wherein each label is subsequently easily removable from the produce item.

A further object is to provide a dual image label, and method of making same, for use on produce items which provides an effective, cost efficient manner of applying an authentication code to thwart counterfeiters.

A further object is to provide a label for application to individual produce items wherein each label has dual image layers, and an intermediate opaque layer, and wherein the problem of “curling” has been overcome.

Further objects and advantages will become apparent from the following description and drawings, wherein:

### BRIEF DESCRIPTION OF DRAWINGS

FIGS. 1-3 are schematic illustrations which describe the prior art problem of “curling” referred to in the specification;

FIG. 1 is a schematic illustration of a prior art produce label showing a single label carried on a release liner prior to being applied to a produce item;

FIG. 2 is a schematic illustration of the produce label as shown in FIG. 1 after the release liner has been removed and the label has been applied to a produce item such as an apple;

FIG. 3 is a schematic illustration of the label shown in FIG. 2 showing the label as it has begun to curl prior to falling off the produce item;

FIG. 4 is a sectional schematic representation (not to scale for the sake of illustration) of the dual image label 110 according to the present invention;

FIGS. 5-8 are schematic illustrations which represent the method of forming the multi-layered label 110 illustrated in FIG. 4;

FIG. 5 is a schematic illustration showing the formation of an elongated and transparent label film strip along with a pressure sensitive adhesive layer and a release liner, prior to any of the ink layers being applied;

FIG. 6 is a schematic illustration showing the application of a plurality of reverse printed images to the upper surface of the film strip;

FIG. 7 is a schematic illustration of the next step of the method wherein an opaque coating is applied over each of the reverse images;

FIG. 8 is a schematic illustration showing the application of a plurality of front or forward printed images over the opaque coating; and

FIG. 9 is a schematic representation of the dual image label shown in FIG. 4 wherein an additional and optional varnish coating has been applied to the top of the label.

### DETAILED DESCRIPTION OF THE DRAWINGS

As an introductory matter, the labels disclosed herein may be utilized in manual labelers and automatic equipment for applying adhesive labels to produce, such as the standard Sinclair model RM6 or SPRM6 labeling machine (as shown and described in LaMers U.S. Pat. Nos. 4,217,164; 4,303,461; 4,454,180; 4,547,252; and Briggs et al U.S. Pat. No. 4,896,793, all of which are incorporated herein by reference as though set forth in full). The Sinclair model RM6 and model SPRM6 machines are commercially available from Sinclair Systems International, LLC, 3115 South Willow Avenue, Fresno, Calif. 93725. As is known in this art, a label web carries a plurality of labels wherein each of said labels may be applied to, and subsequently easily removable from, the surface of single items of produce.

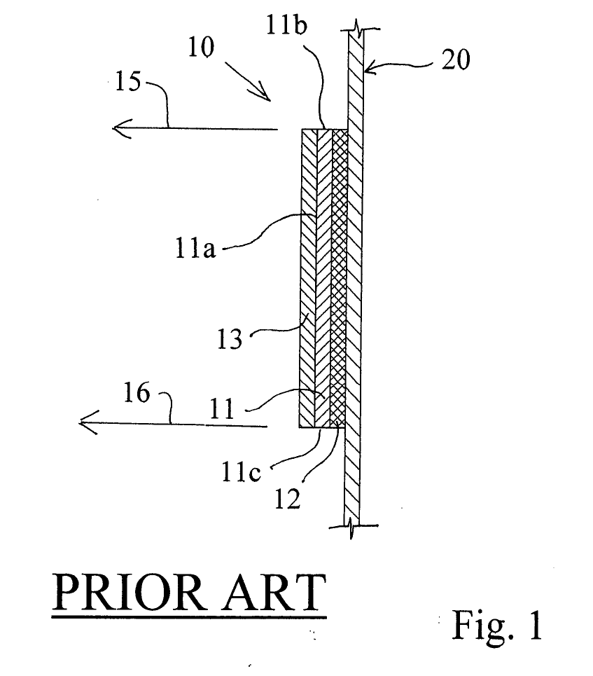

FIGS. 1-3 are schematic illustrations which describe the prior art problem of “curling” referred to above.

As shown in FIG. 1, an individual prior art label 10 is shown carried on a release liner 20. Release liner 20 is typically a robust paper and is held under tension. Label 10 includes three layers including a polymer film layer 11, an adhesive layer 12 carried by the back or reverse side of polymer film 11 and an ink layer 13. Ink layer 13 is applied to the front surface 11a of film 11 and, as shown in FIG. 1, ink layer 13 will cover a large portion of the upper or front surface 11a of film 11. As the ink layer 13 dries, it shrinks and tends to exert force on film 11 in the direction of arrows 15 and 16, which forces tend to pull the upper and lower edges 11b and 11c (and the side edges) of film 11 away from release liner 20. However, the curling forces shown by arrows 15 and 16 are resisted by the release liner 20 being held in tension and cooperating with adhesive 12.

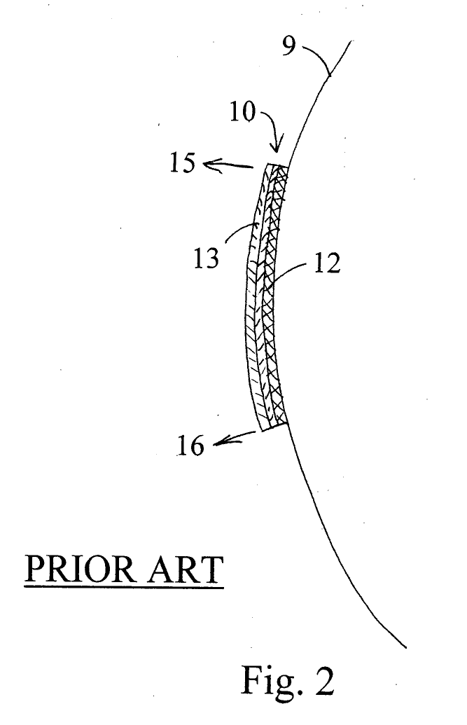

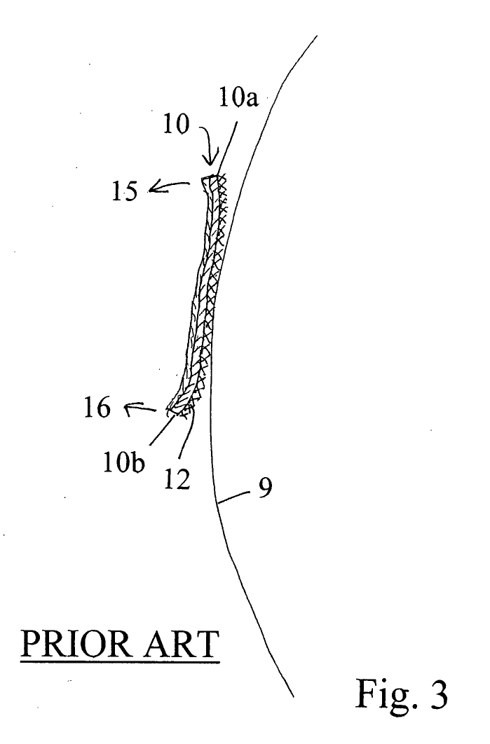

As shown in FIG. 2, prior art label 10 of FIG. 1 has been separated from release liner 20 and, as is shown, applied to the surface of a produce item 9 such as an apple. Adhesive layer 12 holds label 10 against the surface of produce item 9. It is significant to note that in FIG. 2, the release liner, as shown in FIG. 1, is no longer cooperating with adhesive layer 12 to resist the curling forces 15 and 16 created by the drying of ink layer 13. As shown in FIG. 3, the curling forces 15 and 16 have overcome the adhesion between adhesive layer 12 and the surface of produce item 9 and prior art label 10 is having its upper and lower edges 10a and 10b separate from the surface of produce item 9. Produce label 10 will soon fall off the surface of the produce item 9. This curling phenomenon is overcome by the present invention, as shown and described in detail below.

The present invention overcomes the prior art “curling” problem stated above by the following techniques:

1) Using a solvent based ink in making the opaque layer, as opposed to a UV curable ink or a water based ink.

2) Heating the plastic film to between 110° F. and 135° F. prior to application of the three layers of ink.

The three main categories of inks available for use on produce labels are water based inks, solvent based inks and UV (ultraviolet) curable inks. The UV curable inks have large “shrink factors” of typically 15% to 45%, which means the freshly applied wet ink will shrink vertically and horizontally by 15% to 45% during the course of drying [see “Polyester Mesh Capability Study” by Dawn M. Hohl and Dennis D. Hunt, published by Screen Printing Technical Foundation (1991) at page 4]. These shrink factors are unacceptably large for produce labeling, because the dried ink will cause excessive curling of the labels as described above. The shrink factors for solvent based inks and water based inks are considerably smaller than for UV curable inks.

As between solvent based inks and water based inks, solvent based inks provide a greater opacity, due in part to the different pigments used in solvent based inks as compared with those used in water based inks. We have determined that the best ink to use for the opaque layer is a solvent based ink.

Applicants believe that heating the plastic film causes a slight thermal expansion of the film prior to application of the layers of ink to the film. As the ink begins to shrink as it dries and cools down to ambient temperature, the heated film shrinks somewhat as it cools. The “relative shrinkage” between the ink and the film is thereby minimized, and the “curling” forces reduced.

In addition to the above techniques for reduction of curling, applicants believe the use of a solvent based ink for the opaque layer, in conjunction with water based ink used to form images on both sides of the opaque layer, may contribute to the reduction of curling.

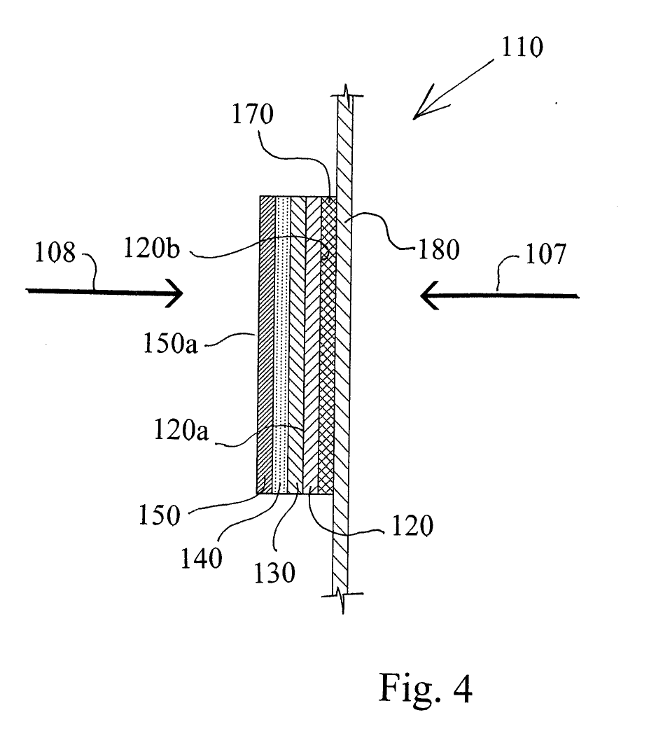

FIG. 4 is a sectional view of a single label carried by a “label strip” according to the invention. Label 110 includes a base layer or film strip 120 which is a transparent plastic film, preferably low density polyethylene or polyester. The film strip 120 has an upper surface 120 a and a lower surface 120 b. The lower surface 120 b carries a transparent, pressure sensitive adhesive 170. A split, two part release liner 180 is carried below the pressure sensitive layer 170 of adhesive. The film strip 120, along with adhesive layer 170 and release liner 180, is elongated and carries thousands of individual labels.

In the preferred method of fabricating the finished label strip 110, the film strip 120 along with the layer of pressure sensitive adhesive 170 and release liner 180 are heated to between 110° F. and 135° F. (preferably between 120° F. and 135° F.) and then the printing of the three ink layers is performed as described below. A first layer of water based ink 130 is applied to the upper surface 120a of film strip 120. The water based ink layer 130 contains a “reverse” image which is intended to be viewed from the lower or back side of the finished label 110 as indicated by reference numeral and arrow 107. The reverse image is “345” when viewed from the back side as shown by arrow 107. The reverse image can be an authentication legend such as a trademark of a branded produce item, or an authentication legend comprising an alphanumeric code. Alternatively, the reverse image could be a promotional image, such as Web site addresses, sweepstakes, cross referencing of other complimentary products, advertising, and interesting communications such as fortunes, rhymes, recipes, treasure hunts, etc. The reverse image allows the doubling of the available printing surface on the otherwise very small label space, while minimizing the requirement for additional operational procedures and costs. By printing each layer on the same side of the label, while allowing legibility on either side, a significant gain in message productivity for produce labels has been achieved.

The next step is to apply an opaque layer or coating 140 over the reverse printed images on layer 130. It is significant to note that the opaque layer 140 preferably covers the entire upper surface of transparent film strip 120. The ink used to formulate the opaque layer 140 is preferably a solvent based ink that is white in color. One such ink that has proven successful is Poly-Gloss White from Flint Group having a Web site at www.na.flintgrp.com The opaque coating 140 is applied with a coat weight of between 3.2 and 4.8 grams per square meter on a dry coat basis and between 4.7 and 7.1 grams per square meter on a wet coat basis. The minimum coat weight is necessary in order for the opaque coating 140 to prevent images on either side of the opaque coating from being visible through the opaque coating. It is also simultaneously necessary for the coat weight of the opaque layer 140 to be sufficiently small to prevent the labels from curling and falling off the produce item to which it is ultimately applied. It has been found that the above stated range of coat weight using the given Poly-Gloss White solvent based coating is acceptable for these purposes.

After the opaque coating 140 has been applied, a plurality of front, printed images is applied as illustrated in FIG. 4 as a front or top ink layer 150. The front images are viewed from the front of label 110 as shown by arrow 108 in FIG. 4.

Although not shown in FIG. 4, in many ultimate uses of the label strip 110, it is advantageous to apply a solvent based varnish coating to the upper or top surface 150a of ink layer 150 in order to protect the water based ink in the layer of front printed images contained on the upper or top ink layer 150.

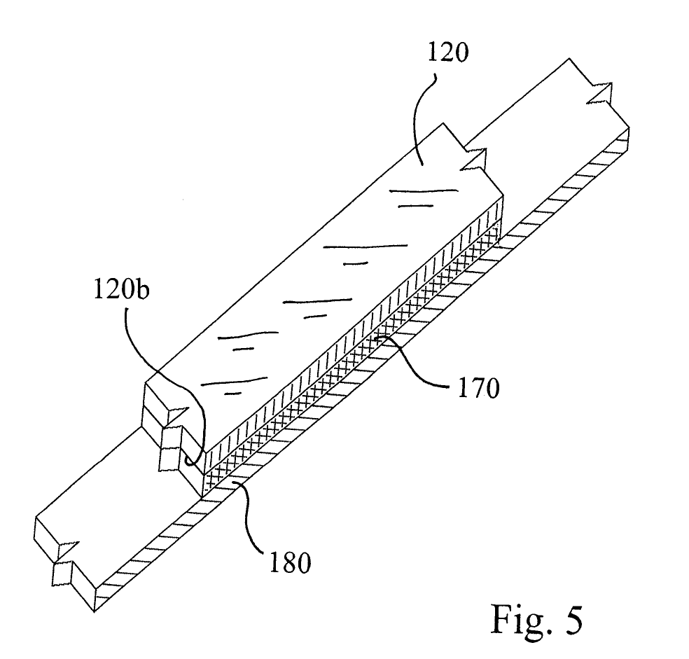

FIGS. 5-8 are schematic illustrations which represent the method of forming the multi-layered label 110 illustrated in FIG. 4.

As shown in FIG. 5, an elongated and transparent label film strip made of a thin plastic polymer film 120 is formed. The film is preferably low density polyethylene and is formed by techniques known in the prior art. In the preferred form of practicing the invention, a transparent pressure sensitive adhesive layer 170 and release liner 180 are applied to the lower surface 120b of film strip 120, as known in the art, before any of the printing steps have been performed. It is significant to note that in the printing steps described below, the transparent film 120 is supported by release liner 180. Release liner 180 is a relatively strong, split two part paper liner subjected to tension as the elongated strip, shown in FIG. 5, is subjected to the printing steps described below. Since the thin film strip 120 is supported by release liner 170, which is in turn held in tension, the release liner resists any tendency of film strip 120 to “curl” during the printing process, itself.

In the preferred method of forming the assembled label 110, as shown in FIG. 4, the film strip 120, adhesive layer 170 and release liner 180, are all heated to between 110° F. and 135° F. (and preferably between 120° F. and 135° F) and are maintained at that temperature while the three separate layers of ink are applied.

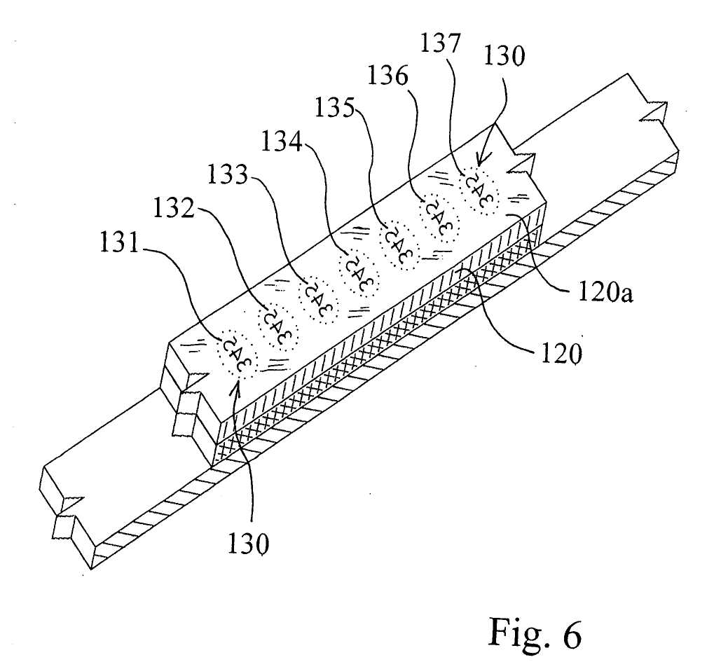

FIG. 6 illustrates the application of a plurality of reverse printed images, shown generally as 130, to the upper surface 120 a of film strip 120. Each of the individual reverse printed images 131-137 will ultimately be used on a separate label. A water based ink is used to form the reverse images. The dashed oval lines around images 131-137 represent the lines which will eventually be die cut to form individual labels.

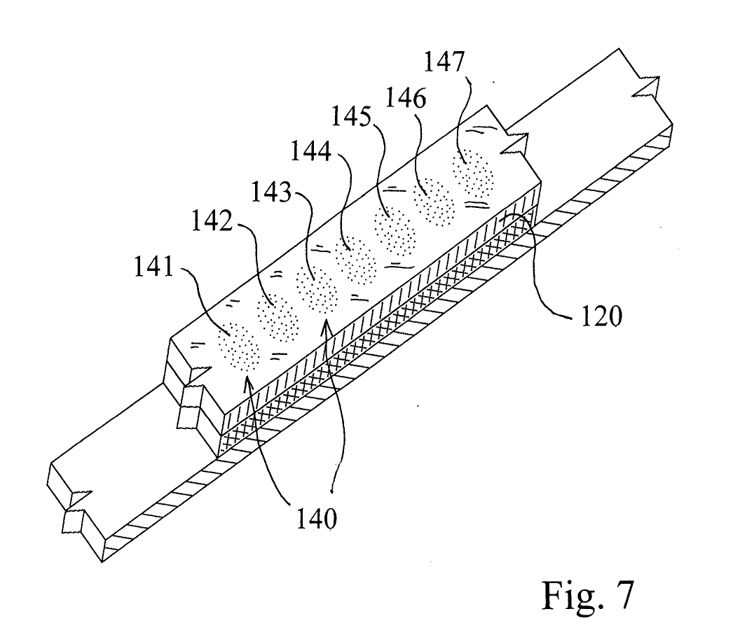

As shown in FIG. 7, a solvent based opaque coating layer shown generally as 140 is applied over each of the reverse images shown in FIG. 6. The reverse images of FIG. 6 are not visible in FIG. 7 because of the individual opaque layers 141-147 covering each of the reverse images 131-137 shown in FIG. 6. As a practical matter, it is cost efficient to apply the opaque coating 140 as a “flood coat” over the entire exposed surface of the film 120 as well as over the reverse images 131-137. In FIG. 7 the opaque layer is shown as being applied as a “spot coat” over the area which will eventually be die cut into individual labels. The coat weight of opaque coating 140 is critical in that it must be sufficiently great to prevent images on either side of the coating 140 from being visible through the coating, but simultaneously, the coat weight must be sufficiently small to prevent “curling.” We have found that a coat weight of between 3.2 and 4.8 grams per square meter on a dry coat basis and between 4.7 and 7.1 grams per square meter on, a wet coat basis is suitable for the preferred white colored opaque coating 140 obtained from Flint Group as described above.

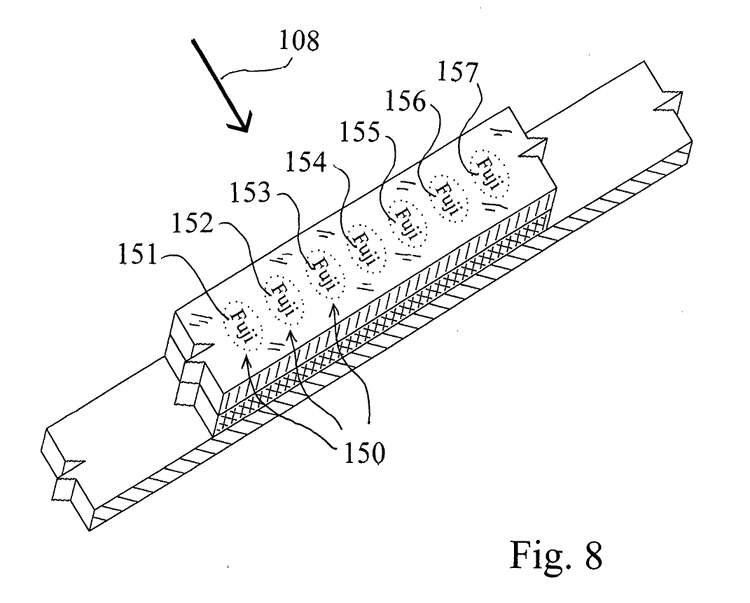

FIG. 8 illustrates the next step in the process of forming the label 110 as shown in FIG. 4 wherein a plurality of front printed images shown generally as 150 is applied over opaque coating 140. As shown in FIG. 8 the individual front or forward images 151-157 are formed in registration with first images 131-137. The front or forward images are applied with a water based ink and, as shown in FIG. 8, the forward image is “Fuji,” and is viewed from the front side of the label 110 as shown by arrow 108 in FIGS. 4 and 8.

As shown in FIGS. 6, 7 and 8 and described above, the three ink layers 130,140 and 150 are all applied from the same side (i.e. the upper side) of film 120.

As a practical matter, after the images and opaque layer have been applied, the individual labels are die cut and the carrier strip (or release liner) with the plurality of labels is stored on cassettes, as is known in the art. In this fashion, a dual image label web is produced, carrying a plurality of labels which may be stored and later applied to individual produce items, either automatically or manually.

The three ink layers described above (i.e., the reverse image, water based ink layer 130; the solvent based ink opaque layer 140; and the front or forward image, water based ink layer 150 ) are all applied preferably with a Flexographic Press having four printing stations, each station using a different Anilox Roller to apply the ink. An optional, UV cured varnish may be applied to the upper surface of the front or forward printed images to protect the water based ink from citric juices, for example. The press speed is preferably 180 to 200 feet per minute. The table and text below describe a specific example of the method of the invention, including optional Station 5 used to apply a protective top coat of varnish.

### EXAMPLE 1

| | Ink Stations on Flexographic Press | | | | |
|---|---|---|---|---|---|
| Material | Station 1 | Station 2 | Station 3 | Station 4 | Station 5 |
| Ink Color | Blue* | Poly-gloss | Red** | Blue** | Varnish |
| | | White | | | |
| Ink Type | Water Base | Solvent | Water Base | Water Base | UV |
| Flexo | Positive Print | Solid Reverse | Positive Print | Reverse Print | Solid Reverse |
| Plate^{†} | | | | | |
| Anilox | 500 lines | 120 lines | 500 lines | 500 lines | 800 lines |
| Roller | 3.2 BCM^{‡} | 11.5 BCM^{‡} | 3.2 BCM^{‡} | 3.5 BCM^{‡} | 1.9 BCM^{‡} |

*Ink color is not inclusive; it can be selected based on aesthetic characteristics and whether or not the customer would like the hidden message to be visible on the front side of the label. For this message to remain hidden it is best for this ink color to match the background color of the object being labeled (e.g. fruit.)
**Ink color for these two stations is selected solely based on the graphics design which is approved by the customer.
^{†}This describes the type of plate that will be used to lay down the appropriate image.
^{‡}Lines or line scene describes the number of cells per inch that are on the anilox roller and BCM (billion cubic microns per square inch) defines the volume of these cells. The following web site gives a good definition of these two measures http://www.harperscientific.com/anilox-line-screen.asp

To minimize label curl, a solvent based Poly-gloss White was used for the opaque layer. Water based inks were used to print the reverse and front or forward images. These inks minimize the chance of curling while providing good image quality. Typical ink suppliers are American Water Graphics, Inc. (www.awg-ink.com); Flint Group (www.na.flintgrp.com), and INX International (www.inxinternational.com).

See the table above for recommended Anilox Roller size for the various print stations for proper coat weights. Press speed was approximately 180 to 200 feet per minute and web temperature was held between, 120° F. and 135° F.

Another critical issue was to minimize visibility of the hidden text/image which was applied on print Station 2. The color of this ink is typically white and covered the entire label. Since this ink covered the entire label, it was important to select an ink that did not pose a curling issue. All water based inks that were tried did not sufficiently obscure the hidden text nor provide sufficient opacity. UV inks tested were all prone to curling. This was primarily due to the heavy coat needed to cover the hidden text. One ink that did provide sufficient opacity and minimize or prevent curling effect was a solvent based ink (Poly-gloss White from Flint Group). Utilizing that ink at Station 2 with the Anilox Roller, described in the above table, produced a coat weight of 4.0 grams per square meter using a dry coat basis and 5.9 grams per square meter using a wet coat basis. The Anilox Roller should have less than 150 lines per inch and have more than 10 BCM to achieve the required coat weight.

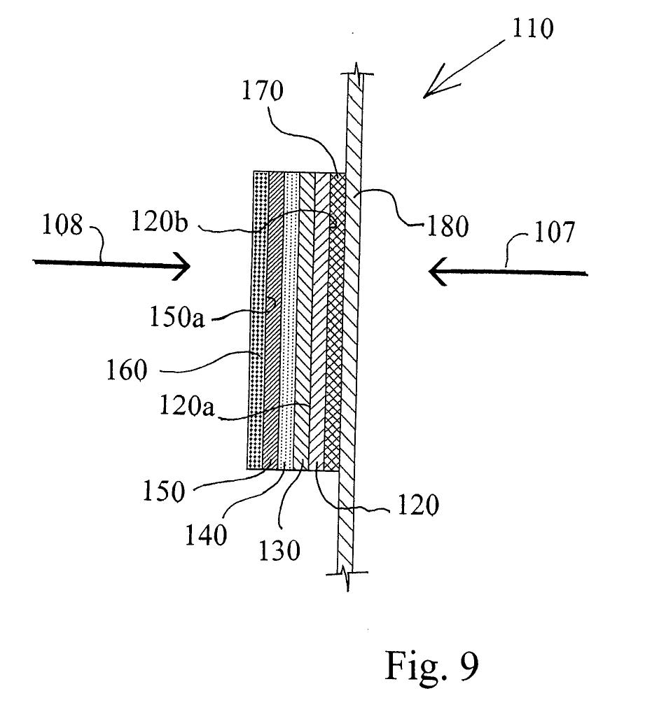

As shown in FIG. 9, a varnish coat 160 is applied as a top coat over the front or forward image ink layer 150. FIG. 9 shows the same label 110 as shown in FIG. 4 (including film strip 120, three ink layers 130, 140, 150 and adhesive layer 170 and release liner 180 ), but with the optional varnish top coat 160 applied. The varnish applied at Station 5 is not necessary for the process but is necessary to protect the water based inks from environmental effects (e.g. citrus oils). For certain products the UV varnish may be substituted for a water based varnish or no varnish at all depending on the application.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. A method of making a dual image label web carrying a plurality of labels wherein each of said labels from said label web may be applied to, and subsequently easily removable from, the surface of single items of produce, comprising the steps:
forming an elongated and transparent label film strip made of thin plastic polymer film, said film strip having upper and lower surfaces,
heating said film strip to between 110° F. and 135° F.,
applying a plurality of reverse printed images to said upper surface of said film strip, wherein each of said reverse printed images is formed with a water based ink, and each of said plurality of reverse printed images is used on a separate label,
applying an opaque coating over each of said reverse images while said film strip is heated to between 110° F. and 135° F., said opaque coating being formed with a solvent based ink, and the coat weight of said opaque coating being sufficiently great to prevent images on either side of said opaque coating from being visible through said opaque coating, and
applying a plurality of front, printed images over said opaque coating, said front, printed images being formed with a water based ink,
wherein said reverse images, said opaque coating and said front printed images are all applied from the same side of said polymer film strip.

2. The method of claim 1 comprising the further preliminary steps:
applying a transparent, pressure sensitive adhesive layer to said lower surface of said film strip, and
applying a release liner to said adhesive layer,
wherein said adhesive layer and release liner are applied prior to application of any ink layers.

3. The method of claim 2 wherein said opaque coating is white in color and has a coat weight of between 4.7 and 7.1 grams per square meter on a wet coat basis.

4. The method of claim 3 wherein said film strip is made of either polyester or low density polyethylene.

5. The method of claim 1 wherein said reverse printed images are authentication codes used to thwart counterfeiters.

6. The method of claim 1 wherein said reverse printed images are promotional images.

7. A method of making a dual image label web carrying a plurality of labels wherein each of said labels from said label web may be applied to, and subsequently easily removable from, the surface of single items of produce, comprising the steps:
forming an elongated and transparent label film strip made of thin plastic polymer film, said film strip having upper and lower surfaces,
heating said film strip to between 120° F. and 135° F.,
applying a plurality of reverse printed images to said upper surface of said film strip, wherein each of said reverse printed images is formed with a water based ink, and each of said plurality of reverse printed images is used on a separate label,
applying an opaque white coating over each of said reverse images while said film strip is heated to between 120° F. and 135° F., said opaque white coating being formed with a solvent based ink, and the coat weight of said opaque white coating being between 4.7 and 7.1 grams per square meter on a wet coat basis,
applying a plurality of front, printed images over said opaque white coating, said front, printed images being formed with a water based ink,
wherein said reverse images, said opaque white coating and said front printed images are all applied from the same side of said polymer film strip.

8. The method of claim 7 comprising the further preliminary steps:
applying a transparent, pressure sensitive adhesive layer to said lower surface of said film strip, and
applying a release liner to said adhesive layer,
wherein said adhesive layer and release liner are applied prior to application of any ink layers.

9. The method of claim 8 wherein said film strip is made of either polyester or low density polyethylene.

10. The method of claim 8 wherein said reverse printed images are authentication codes used to thwart counterfeiters.

11. The method of claim 8 wherein said reverse printed images are promotional images.

12. The method of claim 8 wherein said white, solvent based ink is applied with an Anilox Roller having less than 150 lines per inch and more than 10 billion cubic microns per square inch.

13. The method of claim of claim 12 including the further step of applying a top coat of UV curable varnish over said front, printed images.

14. A dual image label web carrying a plurality of labels wherein each of said labels is adapted to be removably applied to a single item of produce, said label web having multiple layers and comprising:
a base layer comprising a transparent plastic film, said base layer having upper and lower surfaces and being made of either polyester or low density polyethylene,
a layer of transparent, pressure sensitive adhesive carried by said lower surface of said base layer,
a release liner carried below said pressure sensitive adhesive,
a plurality of reverse printed images carried by said upper surface of said base layer, each of said reverse images being formed with a water based ink,
a layer of solvent based ink carried above said plurality of reverse images, said layer of solvent based ink forming an opaque layer and having a coat weight of between 4.7 and 7.1 grams per square meter on a wet coat basis, and
a plurality of front or forward images carried above said opaque layer, said third layer being formed with a water based ink.

15. The apparatus of claim 14 wherein said opaque layer is white.

16. The apparatus of claim 14 wherein said reverse printed images are authentication codes.

17. The apparatus of claim 14 wherein said reverse printed images are promotional images.

18. The apparatus of claim 14 further comprising a top coat of varnish carried above said layer of front or forward images.
